(19) United States
(12) Patent Application Publication
(10) Pub. No.: US 2010/0253663 A1
(43) Pub. Date: Oct. 7, 2010

(54) COUNTER ELECTRODE DRIVE CIRCUIT AND COUNTER ELECTRODE DRIVING METHOD

(76) Inventor: Kohji Ogata, Osaka (JP)

Correspondence Address: HARNESS, DICKEY & PIERCE, P.L.C., P.O. BOX 8910, RESTON, VA, 20195, US

(21) Appl. No.: 12/734,989

(22) PCT Filed: Sep. 1, 2008
(86) PCT No.: PCT/JP2008/065695

§ 371 Date: Jun. 8, 2010

(30) Foreign Application Priority Data
Dec. 14, 2007 (JP) 2007-323765

(51) Int. Cl. G06F 3/038

(52) U.S. Cl. 345/208; 345/90

(57) ABSTRACT

A counter electrode drive circuit of at least one embodiment of the present invention includes: an amplifier for generating a voltage to be applied to a counter electrode; a voltage detecting section for detecting whether the voltage to be applied to the counter electrode at a rise and at a fall of a voltage waveform that is to be applied to the counter electrode is higher or lower as compared to two threshold voltages; and a clock generating section for (i) reducing a power capacity of the amplifier in a case where the voltage to be applied to the counter electrode is higher than a higher first threshold voltage, and (ii) reducing the power capacity of the amplifier in a case where the voltage to be applied to the counter electrode is lower than a lower second threshold voltage. This allows providing a counter electrode drive circuit which can eliminate sounds from being heard from a liquid crystal display device, while holding down the amount of power consumption.

### TECHNICAL FIELD

The present invention relates to a counter electrode drive circuit and a counter electrode driving method, each of which is used for a liquid crystal display device.

### BACKGROUND ART

Currently, cram-shell type mobile phones are structured to have the ears be placed against an LCD (Liquid Crystal Display) during a telephone conversation. Hence, sounds that are heard from the LCD interfere with the telephone conversation, and thus such sounds are currently a major issue in liquid crystal modules that are used for mobile phones.

Conventionally, in driving liquid crystals, a counter electrode is mostly driven in a period of a drive that inverts a common voltage of an audible range. Particularly with the QVGA class, the period of the drive that inverts the common voltage is around 11 KHz to 13 KHz, which is within an audible range for humans, particularly easily heard by the ears.

Thus, conventionally, in order to prevent the sounds from being heard, the period of the drive that inverts the common voltage is made to be in a range that is outside the audible range of humans. In other words, a frequency that inverts the common voltage is raised.

Patent Literature 1 discloses a technique of inverting a polarity of a counter electrode and a polarity of a pixel by synchronizing with a timing of selecting/non-selecting data signal lines.

Patent Literature 1

Japanese Patent Application Publication, Tokukai, No. 2007-156336 A (Publication Date: Jun. 21, 2007)

### SUMMARY OF INVENTION

However, if the frequency is raised, although no sound is heard, the number of times switching of ON and OFF is carried out increases. This causes an increase in the amount of electricity consumption. In fact, a transistor that drives the counter electrode consumes electricity at a time when the transistor is turned ON and OFF.

Accordingly, the inventors of the present invention focused on the following points in considering a way of eliminating the sounds heard without raising the frequency, in other words, eliminating generation of the sounds.

The cause of the generation of the sounds in a more detailed view is that, as illustrated in FIG. 7, when the transistor is turned ON, the voltage exceeds VCOM(H) for a moment in a slightly overshot manner, and in opposite, when the transistor is turned OFF, the voltage falls below VCOM(L) for a moment in a slightly undershot manner.

This is because when the transistor is turned ON, an electric current flows at once, thereby causing a voltage value to reach a slightly higher value than an actual high-level VCOM(H) (a slightly lower value than an actual VCOM(L)). As a result, the ON and OFF cycles are heard.

Moreover, in the case of Patent Literature 1, the overshooting and undershooting are still occurring, and the sounds are still generated in a range in which humans cannot hear with their ears (outside their audible range). Thus, Patent Literature 1 is not a measure that completely cuts off the root of sound generation.

The present invention is accomplished in view of the foregoing problem, and its object is to provide a counter electrode drive circuit and a counter electrode driving method, each of which eliminates a state in which sounds are heard from a liquid crystal display device, while holding down power consumption.

In order to attain the object, a counter electrode drive circuit for AC driving a counter electrode used in a liquid crystal display device includes: an amplifier for generating a voltage to be applied to the counter electrode; a voltage detecting section for detecting whether the voltage to be applied to the counter electrode at a rise and at a fall of a voltage waveform that is to be applied to the counter electrode is higher or lower as compared to two threshold voltages; and an amplifier driving section for (i) reducing a power capacity of the amplifier in a case where the voltage to be applied to the counter electrode is higher than a higher threshold voltage and (ii) reducing the power capacity of the amplifier in a case where the voltage to be applied to the counter electrode is lower than a lower threshold voltage.

Moreover, in order to obtain the object, a counter electrode driving method of the present invention is a counter electrode driving method for AC driving a counter electrode used in a liquid crystal display device, which counter electrode driving method includes: generating, by use of an amplifier, a voltage to be applied to the counter electrode; detecting whether the voltage to be applied to the counter electrode at a rise and at a fall of a voltage waveform that is to be applied to the counter electrode is higher or lower as compared to two threshold voltages; and reducing a power capacity of the amplifier in a case where (i) the voltage to be applied to the counter electrode is higher than a higher threshold voltage, and (ii) the voltage to be applied to the counter electrode is lower than a lower threshold voltage.

According to the configuration, (i) a voltage to be applied to the counter electrode is generated by use of an amplifier, (ii) whether the voltage to be applied to the counter electrode at a rise and a fall in a voltage waveform that is to be applied to the counter electrode is higher or lower as compared to two threshold voltages is detected, (iii) a power capacity of the amplifier is reduced in a case where the voltage to be applied to the counter electrode is higher than a higher threshold voltage, and (iv) the power capacity of the amplifier is reduced in a case where the voltage to be applied to the counter electrode is lower than a lower threshold voltage.

This causes the voltage waveform to be rounded in a case where the voltage applied to the counter electrode is higher than the higher threshold voltage and in a case where the voltage to be applied to the counter electrode is lower than a threshold voltage. Hence, it is possible to prevent the voltage waveform from overshooting and undershooting at the rise and at the fall of the voltage waveform. That is to say, it is possible to prevent the counter electrode from being applied a voltage that exceeds a stationary value, at the rise and at the fall of the voltage waveform. As a result, it is possible to prevent sounds from being heard, which sounds are caused by such overshooting and undershooting. Furthermore, according to the present invention, the voltage waveform is not always rounded, but is rounded in a case where the voltage to be applied to the counter electrode is higher than the higher threshold voltage and in a case where the voltage to be applied to the counter electrode is lower than the threshold voltage, by making use of the two threshold voltages. Therefore, it is possible to secure a sufficient amount of time for a voltage to be sufficiently applied to liquid crystals. Hence, it is possible to prevent the sounds from being heard from the liquid crystal display device, while holding down the amount of power consumption.

Moreover, the counter electrode drive circuit of the present invention is preferably configured in such a manner that the amplifier driving section continuously reduces the power capacity of the amplifier while the voltage waveform is in a high-level state and while the voltage waveform is in a low-level state.

This is advantageous in view of low power consumption, since no sudden change in load occurs during the H or L level. As a result, it is desirable to reduce the amplifier power capacity.

Moreover, the counter electrode drive circuit of the present invention is preferably configured in such a manner that the amplifier driving section recovers the power capacity of the amplifier back to a normal state while the voltage waveform is in a high-level state and while the voltage waveform is in a low-level state. This allows further improvement in display quality, by removing noise that seldom occurs in the counter electrode.

Moreover, the counter electrode drive circuit of the present invention is preferably configured in such a manner that the two threshold voltages are in ranges of 20 to 33.3 and 66.6 to 80, respectively, where an output of the amplifier has a low-level stationary value of 0 and a high-level stationary value of 100.

Of the two threshold voltages, if the lower threshold voltage is too low, that is if the rounding is too small, not as much effect of preventing the sounds from being heard is attained. However, if the lower threshold voltage is too high, that is if the rounding is too large, a sufficient amount of time cannot be secured for applying a voltage to the liquid crystals. Similarly, if the larger threshold voltage is too low, that is if the rounding is too large, a sufficient amount of time cannot be secured for applying a voltage to the liquid crystals, and if the higher threshold value is too high, that is if the rounding is too small, not as much effect of preventing the sounds from being heard is attained.

In response to this, according to the configuration, the two threshold values are in ranges of 20 to 33.3 and 66.6 to 80, respectively, where the output of the amplifier has a low-level stationary value of 0 and a high-level stationary value of 100. The inventors of the present invention have set the lower threshold as not less than 20, and the higher threshold as not more than 80. This prevents the sounds from being heard. Furthermore, the present invention sets the lower threshold as not more than 33.3 and the higher threshold as not less than 66.6. This secures a sufficient time for applying a voltage to the liquid crystals.

Moreover, in order to attain the object, a counter electrode drive circuit of the present invention for AC driving a counter electrode used in a liquid crystal display device is configured in such a manner that a voltage waveform to be applied to the counter electrode is rounded at a start and an end of a rise of the voltage waveform and at a start and an end of a fall of the voltage waveform.

Moreover, in order to attain the object, a counter electrode driving method of the present invention for AC driving a counter electrode used in a liquid crystal display device is a counter electrode driving method including: rounding a voltage waveform to be applied to the counter electrode at a start and an end of a rise of the voltage waveform and at a start and an end of a fall of the voltage waveform.

According to the configuration, a start and an end of a rise and a start and an end of a fall, each of the voltage waveform to be applied to the counter electrode, are rounded. Therefore, it is possible to prevent any overshooting or undershooting of the voltage waveform at the rise and/or the fall of the voltage waveform. That is to say, it is possible to prevent a voltage that exceeds a stationary value from being applied to the counter electrode, at the rise and the fall. Hence, it is possible to prevent the sounds from being heard, which sounds are caused by such overshooting and undershooting. Furthermore, according to the present invention, the voltage waveform is not always rounded, but the start and the end of the rise and the start and the end of the fall of the voltage waveform are rounded. This secures a sufficient amount of time to apply a sufficient amount of voltage to the liquid crystals. As a result, it is possible to prevent the sounds from being heard from a liquid crystal display device, without causing any deterioration in display quality (tone display) of the liquid crystals while also holding down the amount of power consumption.

Moreover, in order to attain the object, a counter electrode drive circuit of the present invention is a counter electrode drive circuit for AC driving a counter electrode used in a display device, wherein a voltage waveform to be applied to the counter electrode is rounded around a stationary value following a rise of the voltage waveform and around a stationary value following a fall of the voltage waveform.

Moreover, in order to attain the object, a counter electrode driving method of the present invention for AC driving a counter electrode used in a liquid crystal display device, is a counter electrode driving method including: rounding a voltage waveform to be applied to the counter electrode around a stationary value following a rise of the voltage waveform and around a stationary value following a fall of the voltage waveform.

According to the configuration, the voltage waveform to be applied to the counter electrode is rounded around a stationary value following a rise and around a stationary value following a fall of the voltage waveform. Therefore, it is possible to prevent the voltage waveform from overshooting or undershooting at the rise and/or the fall. That is to say, it is possible to prevent a voltage that exceeds a stationary value from being applied to the counter electrode, at the rise and the fall. Hence, it is possible to prevent the sounds from being heard, which sounds are caused by such overshooting and undershooting. Furthermore, according to the present invention, the voltage waveform is not always rounded, but the voltage waveform is rounded around the stationary value following the rise and around the stationary value following the fall. This secures a sufficient amount of time for applying a sufficient amount of voltage to the liquid crystals. As a result, it is possible to prevent the sounds from being heard from a liquid crystal display device, while holding down the amount of power consumption.

Moreover, the counter electrode drive circuit of the present invention preferably includes: an amplifier for generating a voltage to be applied to the counter electrode; and an amplifier driving section for supplying a driving signal to the amplifier, the amplifier driving section supplying to the amplifier a driving signal that causes a power capacity of the amplifier to be reduced, so as to round the voltage waveform.

Moreover, the counter electrode drive circuit of the present invention is preferably configured in such a manner that the amplifier includes two field effect transistors, and the driving signal that causes the power capacity of the amplifier to be reduced has a lower high-level voltage value and a higher low-level voltage value than those of a case where the amplifier is normally driven, the high-level voltage value and low-level voltage value being supplied to the amplifier.

Moreover, the counter electrode drive circuit of the present invention is preferably configured in such a manner that the amplifier includes two field effect transistors, and the amplifier driving section controls a voltage inputted into a gate so that a ON resistance of the transistors becomes larger while the voltage waveform is rounded.

Moreover, in order to attain the object, a counter electrode drive circuit of the present invention is a counter electrode drive circuit for AC driving a counter electrode used in a liquid crystal display device, wherein: a voltage waveform to be applied to the counter electrode is rounded at (i) two parts positioned at either ends of the voltage waveform where a rise of the voltage waveform is divided into three parts by two threshold voltages, and at (ii) two parts positioned at either ends of the voltage waveform where a fall of the voltage waveform is divided into three parts by the two threshold voltages.

Moreover, in order to attain the object, a counter electrode driving method of the present invention is a method for AC driving a counter electrode used in a liquid crystal display device, the counter electrode driving method including: rounding a voltage waveform to be applied to the counter electrode at (i) two parts positioned at either ends of the voltage waveform where a rise of the voltage waveform is divided into three parts by two threshold voltages, and (ii) two parts positioned at either ends of the voltage waveform where a fall of the voltage waveform is divided into three parts by the two threshold voltages.

According to the configuration, a voltage waveform to be applied to the counter electrode is rounded at (i) two parts positioned at either ends of the voltage waveform in a case where a rise of the voltage waveform is divided into three parts by two threshold voltages, and at (ii) two parts positioned at either ends of the voltage waveform in a case where a fall of the voltage waveform is divided into three parts by the two threshold voltages. Thus, it is possible to prevent the voltage waveform from overshooting and undershooting at the rise and/or at the fall of the voltage waveform. That is to say, it is possible to prevent a voltage that exceeds a stationary value from being applied to the counter electrode, at the rise and at the fall. Hence, it is possible to prevent the sounds from being heard, which sounds are caused by such overshooting and undershooting. Furthermore, according to the present invention, the voltage waveform is not always rounded, but the voltage waveform in the two parts that are provided on either ends of the voltage waveform in a case where the rise is divided into three parts by the two threshold voltages and the voltage waveform in the two parts that are provided on either ends of the voltage waveform in a case where the fall is divided into three parts by the two threshold voltages are rounded. This secures a sufficient amount of time for applying a sufficient amount of voltage to the liquid crystals. As a result, it is possible to prevent the sounds from being heard from the liquid crystal display device, while holding down the amount of power consumption.

Moreover, in order to attain the object, a counter electrode drive circuit of the present invention for AC driving a counter electrode used in a liquid crystal display device includes: an amplifier for generating a voltage to be applied to the counter electrode, the amplifier including (i) a first transistor made up of a p-channel type field effect transistor that outputs to the counter electrode a high-level voltage of the AC driving and (ii) a second transistor made up of a n-channel type field effect transistor that outputs to the counter electrode a low-level voltage of the AC driving, upon detection of an output from the amplifier, and while the output from the amplifier is outputted from the first transistor, a voltage of a driving signal that is inputted into a gate of the first transistor being lower during a time when the output of the amplifier is higher than a first threshold voltage, as compared to during a time when the output of the amplifier is lower than the first threshold voltage, and while the output of the amplifier is outputted from the second transistor, a voltage of a driving signal inputted into a gate of the second transistor being lower during a time when the output of the amplifier is lower than a second threshold voltage that is lower than the first threshold voltage, as compared to during a time when the output of the amplifier is higher than the first threshold voltage.

According to the invention, it is possible to prevent the sounds from being heard from the liquid crystal display device, while holding down the amount of power consumption.

Moreover, in order to attain the object, a counter electrode drive circuit of the present invention for AC driving a counter electrode used in a liquid crystal display device includes: an amplifier for generating a voltage to be applied to the counter electrode, the amplifier including (i) a first transistor made up of a p-channel type field effect transistor that outputs to the counter electrode a high-level voltage of the AC driving and (ii) a second transistor made up of a n-channel type field effect transistor that outputs to the counter electrode a low-level voltage of the AC driving, upon detection of an output from the amplifier, and while the output of the amplifier is outputted from the first transistor, a voltage of a driving signal that is inputted into a gate of the first transistor being lower during a time when the output from the amplifier is higher than a first threshold voltage and is lower than the high-level voltage, as compared to during a time when the output from the amplifier is lower than the first threshold voltage and is in a high-level state, and while the output of the amplifier is outputted from the second transistor, a voltage of a driving signal inputted into a gate of the second transistor being lower during a time when the output from the amplifier is lower than a second threshold voltage that is lower than the first threshold voltage and the output from the amplifier is higher than the low-level voltage, as compared to during a time when the output from the amplifier is higher than the first threshold voltage and is in a low-level state.

According to the invention, it is possible to prevent the sounds from being heard from a liquid crystal display device, while holding down the amount of power consumption.

Moreover, in order to attain the object, a counter electrode driving method of the present invention is a counter electrode driving method for causing a counter electrode drive circuit to drive a counter electrode, the counter electrode drive circuit AC driving a counter electrode used in a liquid crystal display device, the counter electrode drive circuit including: an amplifier for generating a voltage to be applied to the counter electrode, the amplifier including (i) a first transistor made up of a p-channel type field effect transistor that outputs to the counter electrode a high-level voltage of the AC driving and (ii) a second transistor made up of a n-channel type field effect transistor that outputs to the counter electrode a low-level voltage of the AC driving, which counter electrode driving method includes: detecting an output from the amplifier; while the output of the amplifier is outputted from the first transistor, reducing a voltage of a driving signal inputted into a gate of the first transistor to be lower during a time when the output of the amplifier is higher than a first threshold voltage, as compared to during a time when the output of the amplifier is lower than the first threshold voltage; and while the output of the amplifier is outputted from the second transistor, reducing a voltage of a driving signal inputted into a gate of the second transistor to be lower during a time when the output of the amplifier is lower than a second threshold voltage that is lower than the first threshold voltage, as compared to during a time when the output of the amplifier is higher than the first threshold voltage.

According to the invention, it is possible to prevent the sounds from being heard from a liquid crystal display device, while holding down the amount of power consumption.

Moreover, in order to attain the object, a counter electrode driving method of the present invention is a method of causing a counter electrode drive circuit to drive a counter electrode, the counter electrode drive circuit AC driving a counter electrode used in a liquid crystal display device, the counter electrode drive circuit including: an amplifier for generating a voltage to be applied to the counter electrode, the amplifier including (i) a first transistor made up of a p-channel type field effect transistor that outputs to the counter electrode a high-level voltage of the AC driving, and (ii) a second transistor made up of a n-channel type field effect transistor that outputs to the counter electrode a low-level voltage of the AC driving, which counter electrode driving method includes: detecting an output from the amplifier; while the output of the amplifier is outputted from the first transistor, reducing a voltage of a driving signal inputted into a gate of the first transistor to be lower during a time when the output from the amplifier is higher than a first threshold voltage and is lower than the high-level voltage, as compared to during a time when the output from the amplifier is lower than the first threshold voltage and is in a high-level state; and while the output of the amplifier is outputted from the second transistor, reducing a voltage of a driving signal inputted into a gate of the second transistor to be lower during a time when the output from the amplifier is lower than a second threshold voltage that is lower than the first threshold voltage and the output from the amplifier is higher than the low-level voltage, as compared to during a time when the output from the amplifier is higher than the first threshold voltage and is in a low-level state.

According to the invention, it is possible to prevent the sounds from being heard from the liquid crystal display device, while holding down the amount of power consumption.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 is a waveform chart illustrating a voltage waveform to be applied to an amplifier, in a case where a counter electrode drive circuit of the present embodiment is used.

FIG. 2

FIG. 2 is a block diagram illustrating a counter electrode drive circuit of the present embodiment.

FIG. 3

FIG. 3 is a view schematically illustrating a liquid crystal display device of the present embodiment.

FIG. 4

FIG. 4 is a view schematically illustrating a liquid crystal display device of the present embodiment.

FIG. 5

FIG. 5 is a view illustrating an inner structure of an amplifier of the present embodiment.

FIG. 6

FIG. 6 is a voltage waveform illustrating a gate input voltage; (a) is a voltage waveform illustrating a gate input voltage at a normal time, and (b) is a view illustrating how the gate input voltage is imaged in a case where a power capacity of the amplifier is reduced.

FIG. 7

FIG. 7 is a waveform chart illustrating a voltage waveform to be applied to an amplifier, in a case where a conventional counter electrode drive circuit is used.

### REFERENCE SIGNS LIST

1 voltage detecting section
2 clock generating section (amplifier driving section)
3 amplifier
20 P-channel (field effect transistor)
21 N-channel (field effect transistor)

### DESCRIPTION OF EMBODIMENTS

### Liquid Crystal Display Device

FIG. 3 is a view schematically illustrating a cross-section of a liquid crystal display device of the present embodiment.

As illustrated in FIG. 3, the liquid crystal display device includes a TFT glass substrate 10, a counter electrode 12 provided so as to face the TFT glass substrate 10, a CF (color filter) glass substrate 11 provided on the counter electrode 12, and a FPC (flexible printed circuit) 13.

FIG. 3 illustrates a voltage waveform (later described) to be applied to the counter electrode 12, which voltage waveform is the main feature of the present embodiment. With this voltage waveform, it is possible to prevent sounds from being heard and also unnecessary radiation, which are schematically illustrated by the arrows in FIG. 3. This point is described later.

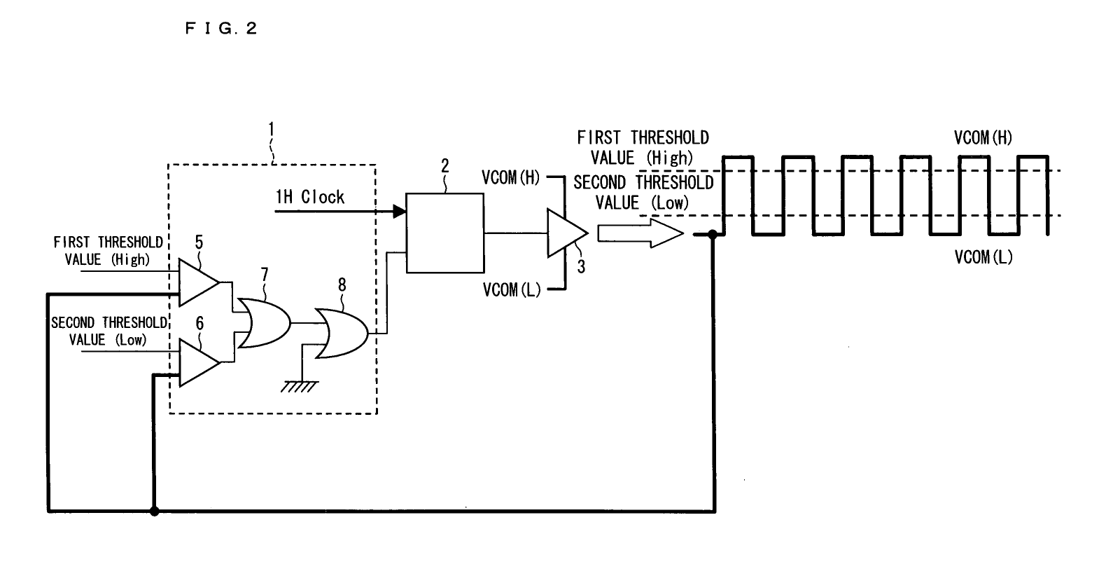

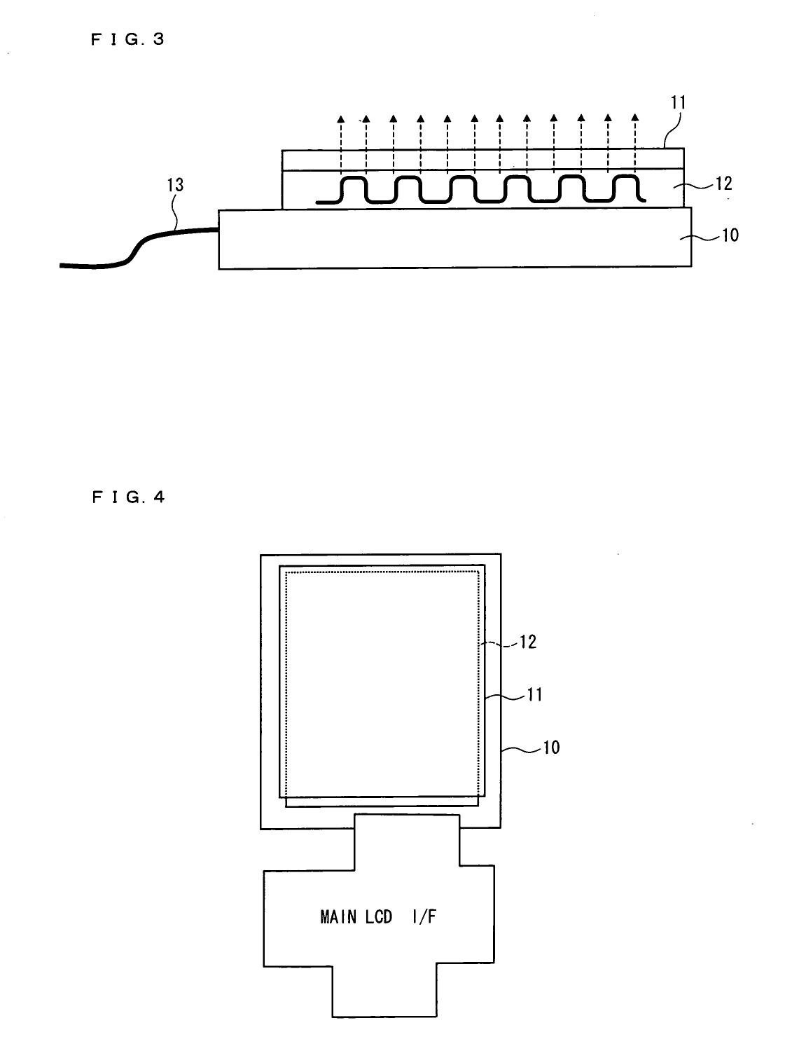

FIG. 4 is a view schematically illustrating a plan view of the liquid crystal display device. As illustrated in FIG. 4, the counter electrode 12 is provided to the CF glass substrate 11, and an AC voltage is applied to the counter electrode 12 from a counter electrode drive circuit provided in a main LCD (liquid crystal display device) of the liquid crystal display device (see FIG. 2).

### Configuration of Counter Electrode Drive Circuit

The following description explains a configuration of the counter electrode drive circuit. The counter electrode drive circuit is provided to a so-called data line drive circuit (source driver; not illustrated).

As illustrated in FIG. 2, the counter electrode drive circuit includes a voltage detecting section 1, a clock generating section (amplifier driving section) 2, and an amplifier (AMP for AC driving the counter electrode) 3.

The voltage detecting section 1 detects whether an output voltage from the amplifier 3 (voltage applied to the counter electrode 12) is higher or lower as compared to a first threshold voltage (voltage detection Point (high)), and whether the output voltage from the amplifier 3 is higher or lower compared to a second threshold voltage (voltage detection Point (low)). The first threshold voltage and second threshold voltage are voltages that satisfy: “VCOM(L)<second threshold voltage<first threshold voltage<VCOM(H)”. Note that VCOM(L) is a low-level stationary value of the amplifier 3, and VCOM(H) is a high-level stationary value of the amplifier 3.

The clock generating section 2 receives (i) a 1H Clock and (ii) an output from the voltage detecting section 1. Based on the received (i) 1H Clock and (ii) output from the voltage detecting section 1, the clock generating section 2 generates a driving signal for the amplifier 3. The amplifier 3 generates, based on the driving signal received from the clock generating section 2, a voltage to be applied to the counter electrode 12. The following description further explains each of the configurations in detail.

Voltage Detecting Section

The voltage detecting section 1 includes a first selector 5, a second selector 6, a first OR gate 7, and a second OR gate 8.

The first selector 5 receives, via an input thereof, (i) an output voltage from the amplifier 3 (application voltage to be applied to the counter electrode) and (ii) the first threshold voltage. The first selector 5 compares the output voltage with the first threshold voltage, and outputs “0” if the first threshold voltage is higher, and outputs “1” if the output voltage from the amplifier 3 is higher.

The second selector 6 receives, via an input thereof, (i) the output voltage from the amplifier 3 and (ii) the second threshold voltage. The second selector 6 compares the output voltage with the second threshold voltage, and outputs “1” if the second threshold voltage is higher, and outputs “0” if the output voltage from the amplifier 3 is higher.

The first OR gate 7 receives the output from the first selector 5 and the output from the second selector 6. The first OR gate 7 determines whether (i) either the output voltage from the amplifier 3 is higher than the first threshold voltage, or the output voltage from the amplifier 3 is lower than the second threshold voltage, or (ii) none of either case is satisfied. The first OR gate 7 outputs “1” in the case of (i), and outputs “0” in the case of (ii).

The second OR gate 8 functions as a level shifter of the clock generating section 2.

Clock Generating Section

The clock generating section 2 generates the driving signal for the amplifier 3 based on the output from the voltage detecting section 1 (“0” or “1”) and the 1H Clock, and drives the amplifier 3 in accordance with the driving signal.

The clock generating section 2 generates two types of driving signals, depending on the output from the voltage detecting section 1. Of the two types of driving signals, one is a driving signal for normally driving the amplifier 3, and the other one is a driving signal for driving the amplifier 3 with its power capacity reduced.

More specifically, when an input of “0” is received from the voltage detecting section 1, the clock generating section 2 generates a driving signal that causes normal driving of the amplifier 3. On the other hand, when the clock generating section 2 receives an input of “1” from the voltage detecting section 1, the clock generating section 2 generates a driving signal that causes driving of the amplifier 3 with its power capacity reduced.

The following description explains one specific example. The clock generating section 2, upon receiving the input of “0” from the voltage detecting section 1, generates for example a 5 V driving signal or a 0 V driving signal at the same timing as the switching of “H” or “L” of the 1H Clock. On the other hand, the clock generating section 2, upon receiving the input of “1” from voltage detecting section 1, generates for example a 4 V driving signal or a 1 V driving signal at the same timing as the switching of “H” or “L” of the 1H Clock.

That is to say, when the clock generating section 2 receives the input of “0” from the voltage detecting section 1, the clock generating section 2 generates the 5 V driving signal in a case where the 1H Clock is “H”, and generates the 0 V driving signal in a case where the 1H Clock is “L”. On the other hand, when the clock generating section 2 receives the input of “1” from the voltage detecting section 1, the clock generating section 2 generates a 4 V driving signal in a case where the 1H Clock is “H”, and generates a 1 V driving signal in a case where the 1H Clock is “L”.

Hence, in the case where the clock generating section 2 receives the input of “1” from the voltage detecting section in the case where the 1H Clock is “H”, that is, in the case where the 4 V driving signal is inputted into the amplifier 3, this means that the voltage detecting section 1 had detected a voltage lower than the second threshold voltage.

Moreover, in the case where the clock generating section 2 receives the input of “1” from the voltage detecting section 1 in the case where the 1H Clock is “L”, that is, in the case where the 1 V driving signal is inputted into the amplifier 3, this means that the voltage detecting section 1 had detected a voltage higher than the first threshold voltage.

Moreover, in the case where the clock generating section 2 receives the input of “0” from the voltage detecting section 1, that is, in the case where the 0 V or 5 V driving signal is inputted into the amplifier 3, this means that the voltage detecting section 1 had detected a voltage that is higher than the second threshold voltage and lower than the first threshold voltage.

The threshold voltage values provided in this description are simply examples, and the threshold voltage values are not particularly limited as long as a driving signal for driving the amplifier 3 has a lower high-level and a higher low-level in the case where the input of “1” is received from the voltage detecting section 1, as compared to a high-level and a low-level in the case where the input of “0” is received from the voltage detecting section 1.

Amplifier

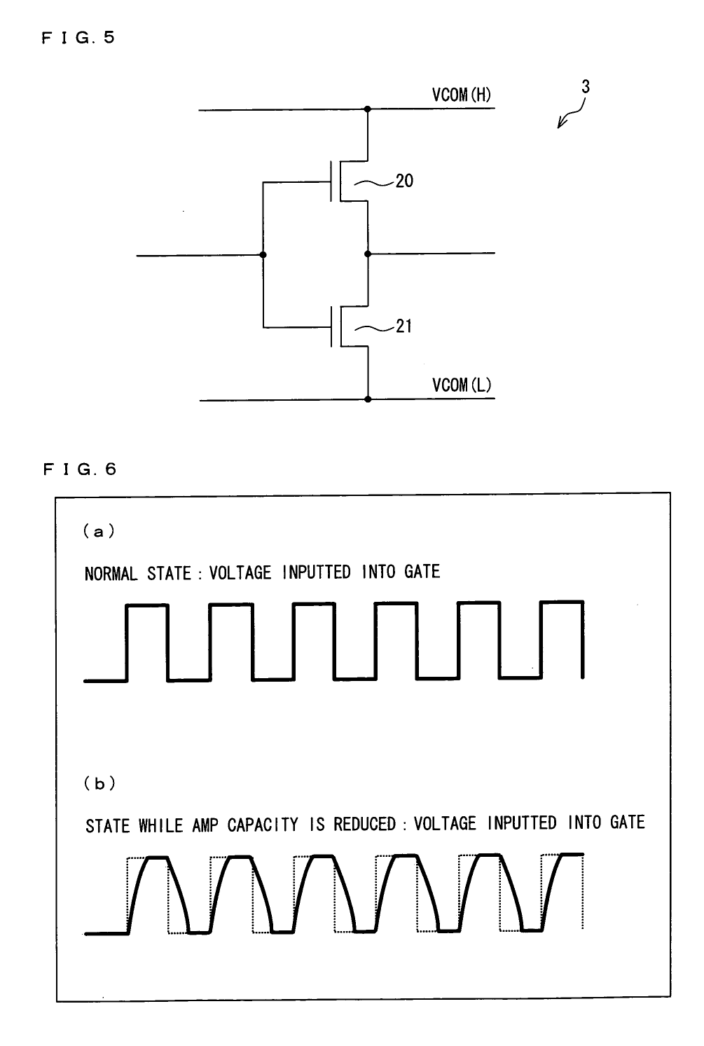

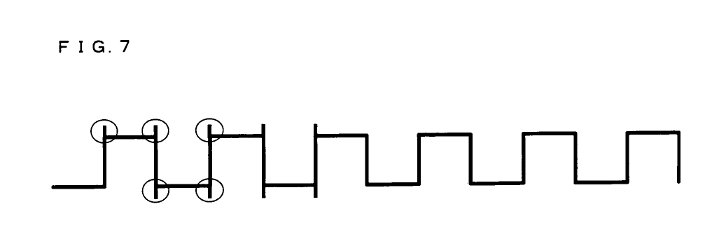

The amplifier 3, as illustrated in FIG. 5, includes two field effect transistors (P-channel 20, N-channel 21) that are connected in series. The driving signal is inputted from the clock generating section 2 to gates of each of the field effect transistors 20 and 21.

The P-channel 20 has its source connected to the VCOM(H). Drains of the P-channel 20 and N-channel 21 are connected to each other. Further, the N-channel 21 has its source connected to the VCOM(L). An output section is provided between the drain of the P-channel 20 and the drain of the N-channel 21.

The amplifier 3 receives a driving signal from the clock generating section 2, and carries out normal driving in a case where the amplifier 3 receives a driving signal for normally operating the amplifier 3, and carries out a driving reduced in power capacity in a case where the amplifier 3 receives a driving signal for driving the amplifier 3 with its power capacity reduced.

When a high-level voltage is inputted into the amplifier 3, the gate of the N-channel 21 turns ON and the gate of the P-channel 20 turns OFF, which causes an output of the VCOM(L). On the other hand, when a low-level voltage is inputted into the amplifier 3, the gate of the P-channel 20 turns ON and the gate of the N-channel 21 turns OFF, which causes an output of the VCOM(H).

Reducing the power capacity of the amplifier means that the voltage that is inputted into the gate of the P-channel 20 and N-channel 21 changes slowly.

In the normal driving, rise and fall of the output waveform (voltage waveform) is steep, however in the driving reduced in power capacity, the rise and fall of the output waveform is rounded.

In FIG. 6, (a) is a voltage waveform showing a gate input voltage of the normal driving, and (b) of FIG. 6 is a view illustrating how the gate input voltage is imaged in a case where the power capacity of the amplifier is reduced.

Operation of Counter Electrode Driving Section

The following description explains how the counter electrode driving section operates.

The output (output voltage) from the amplifier 3 is inputted into the first selector 5 and the second selector 6.

The first selector 5 compares which of the received output and the first threshold voltage is higher or lower, and outputs “1” to the first OR gate 7 if the output is higher than the first threshold voltage, and outputs “0” to the first OR gate 7 if the first threshold voltage is higher than the output.

The second selector 6 compares which of the received output and the second threshold voltage is higher or lower, and outputs “1” to the first OR gate 7 if the output is lower than the second threshold voltage, and outputs “0” to the first OR gate 7 if the second threshold voltage is higher than the output.

The first OR gate 7 receives a signal of any one of “1,0”, “0,1”, and “0,0”. When the first OR gate 7 receives either the “1,0” or the “0,1”, the first OR gate 7 outputs “1” to the second OR gate 8, and when the first OR gate 7 receives the “0,0”, the first OR gate 7 outputs “0” to the second OR gate 8.

The clock generating section 2 receives (i) the 1H Clock and (ii) the signal from the second OR gate 8 of “0” or “1”.

The clock generating section 2 normally drives the amplifier 3 in a case where the “0” is received from the second OR gate 8. The clock generating section 2 is driven by the second OR gate 8 that serves as a level shifter.

On the other hand, in a case where the clock generating, section 2 receives the “1” from the second OR gate 8, the clock generating section 2 reduces the power capacity of the amplifier 3.

More specifically, as described above, when the amplifier 3 is normally driven, the amplifier 3 is driven, for example, by “0 V or 5 V”, and when the amplifier 3 is driven reduced in power capacity, the amplifier 3 is driven, for example, by “1 V or 4 V”.

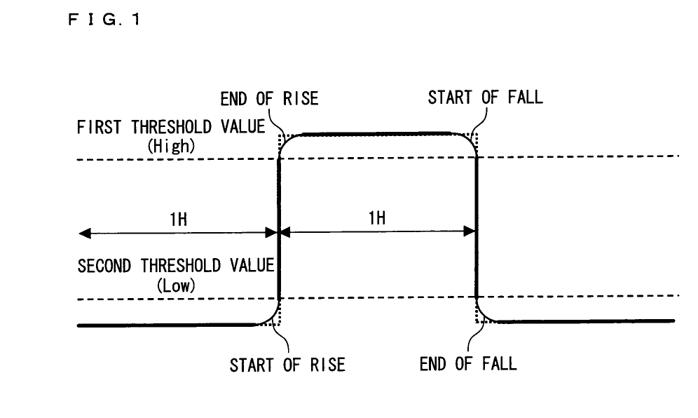

From the above configuration and operation, the output waveform from the amplifier becomes a waveform as like the waveform illustrated in FIG. 1.

That is to say, a conventionally rectangular waveform, i.e. a waveform formed by lines intersecting at right angles with each other, is rounded in the present embodiment by reducing the power capacity of the amplifier 3 while the output from the amplifier 3 is higher than the first threshold voltage and while the output from the amplifier 3 is lower than the second threshold voltage.

As described above, while the output from the amplifier 3 is higher than the first threshold voltage (end of rise and start of fall), a voltage higher than the normal driving is applied (e.g., from 0 V to 1 V) to round a high-level output waveform. Similarly, while the output from the amplifier 3 is lower than the second threshold voltage (start of rise and end of fall), a voltage lower than that of the normal driving is applied (e.g., from 5 V to 4 V) to round a low-level output waveform.

For easy explanation, in FIG. 1, rounded sections in the waveform are illustrated by thin lines, and other sections are illustrated by bold lines. Moreover, levels of the first threshold voltage and second threshold voltage are illustrated by alternate long and short dash lines.

By rounding the waveform as illustrated in FIG. 1, it is possible to prevent the voltage from becoming higher than the VCOM(H) or becoming lower than the VCOM(L), at the rise or fall of the output waveform.

Hence, this prevents sounds from being heard and unnecessary radiation that are caused by the voltage becoming higher than the VCOM(H) and the voltage becoming lower than the VCOM(L). Furthermore, no change occurs to inversion cycles of the counter electrode. Thus, is possible to attain low power consumption.

The output waveform illustrated in FIG. 1 may also be expressed as follows: “a waveform rounded at a start and an end of a rise and at a start and an end of a fall”, “a waveform of a voltage waveform to be applied to a counter electrode that is rounded around a stationary value following a rise and around a stationary value following a fall”, and “a waveform rounded at (i) two parts positioned at either ends of the voltage waveform where a rise is divided into three parts by two threshold voltages, and at (ii) two parts positioned at either ends of the voltage waveform where a fall is divided into three parts by the two threshold voltages”. In the embodiment, the stationary values are the VCOM(L) and the VCOM(H).

The amplifier 3 includes two field effect transistors, and the clock generating section 2 controls a voltage inputted into their gates so that an ON resistance of the transistor is increased upon rounding the voltage waveform.

One Example of Calculating First Threshold Voltage and Second Threshold Voltage

Described next is how to set the aforementioned first threshold voltage and second threshold voltage. Note that the first threshold voltage and the second threshold voltage described in the present embodiment are just simply examples. How the first threshold voltage and second threshold voltage are determined depends on various elements such as performance of the amplifier, and therefore the description in this embodiment is simply that of just one example. A QVGA class liquid crystal module is described as one example in the present embodiment, although it is not limited to this example.

A clock for QVGA is 4.8 MHz, and 1H for QVGA is 20 KHz. In this case, a time required for the 1H is 50 μs. Note that a retrace time is 13, with a frame rate of 60 Hz.

A time required for 1H driving is a minimum of 44 μs. Therefore, it is required to keep a rise time (settling time) and a fall time (settling time) of the amplifier within 6 μs. The following description discusses the rise.

A time required for a rise when an amplifier is driven normally is 2 μs. In a case where a power capacity of the amplifier is reduced by 30% (in a case where the power capacity of the amplifier is reduced), a time required for the rise is 8 μm.

Here, VCOM(L) is 0, VCOM(H) is 1; further, a voltage for recovering the power capacity of the amplifier is A, and a voltage for reducing the power capacity of the amplifier is 1−A, each in the case of the rise.

In order to keep the settling time within 6 μs, the following numerical expression is to be satisfied:

{2×(8 μs×A)}+{2 μs×(1-2A)}≦6 μs

Calculation of this inequality obtains A≦0.333 . . . .

Therefore, the second threshold voltage is set as not more than 33.3, and the first threshold voltage is set as not less than 66.7, where the VCOM(L) and VCOM(H) of the second voltage are 0 and 100, respectively.

However, if the first threshold voltage is set as a value extremely high or if the second threshold voltage is set as a value extremely low, less effect is attained in preventing the sounds from being heard.

The inventors of the present invention found that by setting the second threshold voltage as not less than 20 from the VCOM(L) and setting the first threshold voltage as not more than 80% from the VCOM(L) where the VCOM(L) to VCOM(H) is 100%, it is possible to appropriately prevent the sounds from being heard.

The following description deals with the foregoing explanation of “A time required for 1H driving is a minimum of 44 μs”. The value of 44 μs is just one example, however it is necessary that the time required for the 1H driving allows applying a sufficient amount of voltage to the liquid crystals. If no first threshold voltage and second threshold voltage is set and the amplifier is driven so that the output waveform of the amplifier is always rounded, it is not possible to apply a sufficient amount of voltage to the liquid crystals. For example, in a case of a 6SSD, a sufficient amount of voltage can only be applied to the last “GB” of “RGBRGB”. This causes unevenness in color.

In other words, in the present embodiment, a waveform is not only simply rounded, i.e., a power capacity of an amplifier is simply reduced, but also a predetermined voltage value is detected, and the power capacity of the amplifier is reduced by having this detection result serve as a sign. Although it is possible to prevent the sounds from being heard just by reducing the power capacity of the amplifier, in the present embodiment, the power capacity of the amplifier is not just simply reduced; a voltage value is detected, and just a predetermined part of the waveform is rounded based on the detection result. Hence, it is possible to apply a sufficient amount of voltage to the liquid crystals. That is to say, as shown in the present embodiment, it is possible to apply a sufficient amount of voltage to the liquid crystals by detecting high/low of the voltage and reducing the power capacity of the amplifier just in a case where the voltage is not more than a predetermined voltage or is not less than a predetermined voltage.

In the present embodiment, the output from the amplifier is compared with the first threshold voltage and the second threshold voltage, and the output from the amplifier is rounded if the output of the amplifier is higher than the first threshold voltage and if the output of the amplifier is lower than the second threshold voltage. However, the present invention is not limited to this, and the amplifier may be driven so that the output is rounded for example just at a rise and a fall, or just before and after the rise and the fall; and for the rest of the time the amplifier is driven normally. That is to say, the amplifier may be normally driven during a risen state and a fallen state. Note that a time to round the output in the case where the output is rounded before and after the rise and fall may be set by use of, for example, a register.

Moreover, a timing to change the power capacity of the amplifier may be time controlled by use of a register.

One current problem with the liquid crystal module is the problem of sound generation. In the driving of liquid crystals, counter electrodes are AC-driven, which with QVGA class display, the AC-drive is a drive that is carried out within an audible range. Accordingly, measures such as increasing frequency and the like are taken, by driving the counter electrode with an AC drive that is in a range outside the audible range. However, this causes a trade-off that electric current consumption increases. In order to avoid this trade-off, a voltage is detected during the rise and fall of the voltage, thereafter an AMP power capacity is reduced depending on the voltage and a time constant is provided, so that sound is not generated during the counter AC driving. This realizes both a measure against sound generation and a measure for attaining Low-Power.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

As described above, a counter electrode drive circuit and a counter electrode driving method of the present invention causes rounding of a start and an end of rise and a start and an end of a fall, of a voltage waveform to be applied to a counter electrode.

Moreover, as described above, the counter electrode drive circuit and counter electrode driving method of the present invention causes rounding of around a stationary value following a rise and of around a stationary value following a fall, of a voltage waveform applied to the counter electrode.

Moreover, as described above, the counter electrode drive circuit and counter electrode driving method of the present invention causes rounding of (i) two parts positioned at either ends of a voltage waveform to be applied to the counter electrode where the rise of the voltage waveform is divided into three parts by two threshold voltages, and of (ii) two parts positioned at either ends of the voltage waveform where a fall of the voltage waveform is divided into three parts by the two threshold voltages.

Moreover, a counter electrode drive circuit of the present invention includes: an amplifier for generating a voltage to be applied to a counter electrode; a voltage detecting section for detecting whether the voltage to be applied to the counter electrode at a rise and a fall in a voltage waveform to be applied to the counter electrode is higher or lower as compared to two threshold voltages; and an amplifier driving section for reducing a power capacity of the amplifier in a case where the voltage to be applied to the counter electrode is higher than a higher threshold voltage or is lower than a lower threshold voltage.

Moreover, a counter electrode driving method of the present invention (i) generates a voltage to be applied to a counter electrode by use of an amplifier; (ii) detects whether the voltage to be applied to the counter electrode at a rise and at a fall of a voltage waveform to be applied to the counter electrode is higher or lower as compared to two threshold voltages; and (ii) reduces a power capacity of the amplifier in a case where the voltage to be applied to the counter electrode is higher than the higher threshold voltage or is lower than the lower threshold voltage.

Hence, it is possible to provide a counter electrode drive circuit and counter electrode driving method, each of which eliminates sounds from being heard from the liquid crystal display device, while holding down the power consumption.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

A counter electrode drive circuit and a counter electrode driving method of the present invention are applicable in mobile phones or PDAs.

1. A counter electrode drive circuit for AC driving a counter electrode used in a liquid crystal display device,
the counter electrode drive circuit comprising:
an amplifier for generating a voltage to be applied to the counter electrode;
a voltage detecting section for detecting whether the voltage to be applied to the counter electrode at a rise and at a fall of a voltage waveform that is to be applied to the counter electrode is higher or lower as compared to two threshold voltages; and
an amplifier driving section for (i) reducing a power capacity of the amplifier in a case where the voltage to be applied to the counter electrode is higher than a higher threshold voltage and (ii) reducing the power capacity of the amplifier in a case where the voltage to be applied to the counter electrode is lower than a lower threshold voltage.

2. The counter electrode drive circuit according to claim 1, wherein:
the amplifier driving section continuously reduces the power capacity of the amplifier while the voltage waveform is in a high-level state and while the voltage waveform is in a low-level state.

3. The counter electrode drive circuit according to claim 1, wherein:
the amplifier driving section recovers the power capacity of the amplifier back to a normal state while the voltage waveform is in a high-level state and while the voltage waveform is in a low-level state.

4. The counter electrode drive circuit according to claim 1, wherein:
the two threshold voltages are in ranges of 20 to 33.3 and 66.6 to 80, respectively, where an output of the amplifier has a low-level stationary value of 0 and a high-level stationary value of 100.

5. A counter electrode drive circuit for AC driving a counter electrode used in a liquid crystal display device, wherein:
a voltage waveform to be applied to the counter electrode is rounded at a start and an end of a rise of the voltage waveform and at a start and an end of a fall of the voltage waveform.

6. A counter electrode drive circuit for AC driving a counter electrode used in a liquid crystal display device, wherein
a voltage waveform to be applied to the counter electrode is rounded around a stationary value following a rise of the voltage waveform and around a stationary value following a fall of the voltage waveform.

7. The counter electrode drive circuit according to claim 5, comprising:
an amplifier for generating a voltage to be applied to the counter electrode; and
an amplifier driving section for supplying a driving signal to the amplifier,
the amplifier driving section supplying to the amplifier a driving signal that causes a power capacity of the amplifier to be reduced, so as to round the voltage waveform.

8. The counter electrode drive circuit according to claim 7, wherein:
the amplifier has two field effect transistors, and
the driving signal that causes the power capacity of the amplifier to be reduced has a lower high-level voltage value and a higher low-level voltage value than those of a case where the amplifier is normally driven, the high-level voltage value and low-level voltage value being supplied to the amplifier.

9. The counter electrode drive circuit according to claim 7, wherein:
the amplifier includes two field effect transistors, and
the amplifier driving section controls a voltage inputted into a gate so that a ON resistance of the transistors becomes larger while the voltage waveform is rounded.

10. A counter electrode drive circuit for AC driving a counter electrode used in a liquid crystal display device, wherein:
a voltage waveform to be applied to the counter electrode is rounded at (i) two parts positioned at either ends of the voltage waveform where a rise of the voltage waveform is divided into three parts by two threshold voltages, and at (ii) two parts positioned at either ends of the voltage waveform where a fall of the voltage waveform is divided into three parts by the two threshold voltages.

11. The counter electrode drive circuit according to claim 10, comprising:
an amplifier for generating a voltage to be applied to the counter electrode; and
an amplifier driving section for supplying a driving signal to the amplifier,
the amplifier driving section supplying to the amplifier a driving signal that causes a power capacity of the amplifier to be reduced, so as to round the voltage waveform.

12. The counter electrode drive circuit according to claim 11, wherein:
the amplifier includes two field effect transistors, and
the driving signal that causes the power capacity of the amplifier to be reduced has a lower high-level voltage value and a higher low-level voltage value than those of a case where the amplifier is normally driven, the high-level voltage value and low-level voltage value being supplied to the amplifier.

13. The counter electrode drive circuit according to claim 10, wherein:
the two threshold voltages are in ranges of 20 to 33.3 and 66.6 to 80, respectively, where an output of the amplifier has a low-level stationary value of 0 and a high-level stationary value of 100.

14. A counter electrode drive circuit for AC driving a counter electrode used in a liquid crystal display device,
the counter electrode drive circuit comprising:
an amplifier for generating a voltage to be applied to the counter electrode,
the amplifier including (i) a first transistor made up of a p-channel type field effect transistor that outputs to the counter electrode a high-level voltage of the AC driving and (ii) a second transistor made up of a n-channel type field effect transistor that outputs to the counter electrode a low-level voltage of the AC driving,
upon detection of an output from the amplifier, and while the output from the amplifier is outputted from the first transistor, a voltage of a driving signal that is inputted into a gate of the first transistor being lower during a time when the output of the amplifier is higher than a first threshold voltage, as compared to during a time when the output of the amplifier is lower than the first threshold voltage, and while the output of the amplifier is outputted from the second transistor, a voltage of a driving signal that is inputted into a gate of the second transistor being lower during a time when the output of the amplifier is lower than a second threshold voltage that is lower than the first threshold voltage, as compared to during a time when the output of the amplifier is higher than the first threshold voltage.

15. A counter electrode drive circuit for AC driving a counter electrode used in a liquid crystal display device,
the counter electrode drive circuit comprising:
an amplifier for generating a voltage to be applied to the counter electrode,
the amplifier including (i) a first transistor made up of a p-channel type field effect transistor that outputs to the counter electrode a high-level voltage of the AC driving and (ii) a second transistor made up of a n-channel type field effect transistor that outputs to the counter electrode a low-level voltage of the AC driving,
upon detection of an output from the amplifier, and while the output of the amplifier is outputted from the first transistor, a voltage of a driving signal that is inputted into a gate of the first transistor being lower during a time when the output from the amplifier is higher than a first threshold voltage and is lower than the high-level voltage, as compared to during a time when the output from the amplifier is lower than the first threshold voltage and is in a high-level state, and while the output of the amplifier is outputted from the second transistor, a voltage of a driving signal inputted into a gate of the second transistor being lower during a time when the output from the amplifier is lower than a second threshold voltage that is lower than the first threshold voltage and the output from the amplifier is higher than the low-level voltage, as compared to during a time when the output from the amplifier is higher than the first threshold voltage and is in a low-level state.

16. A counter electrode driving method for AC driving a counter electrode used in a liquid crystal display device,
the counter electrode driving method comprising:
generating, by use of an amplifier, a voltage to be applied to the counter electrode;
detecting whether the voltage to be applied to the counter electrode at a rise and at a fall of a voltage waveform that is to be applied to the counter electrode is higher or lower as compared to two threshold voltages; and
reducing a power capacity of the amplifier in a case where (i) the voltage to be applied to the counter electrode is higher than a higher threshold voltage, and (ii) the voltage to be applied to the counter electrode is lower than a lower threshold voltage.

17. A counter electrode driving method of AC driving a counter electrode used in a liquid crystal display device,
the counter electrode driving method comprising:
rounding a voltage waveform to be applied to the counter electrode at a start and an end of a rise of the voltage waveform and at a start and an end of a fall of the voltage waveform.

18. A counter electrode driving method of AC driving a counter electrode used in a liquid crystal display device,
the counter electrode driving method comprising:
rounding a voltage waveform to be applied to the counter electrode around a stationary value following a rise of the voltage waveform and around a stationary value following a fall of the voltage waveform.

19. A counter electrode driving method for AC driving a counter electrode used in a liquid crystal display device,
the counter electrode driving method comprising:
rounding a voltage waveform to be applied to the counter electrode at (i) two parts positioned at either ends of the voltage waveform where a rise of the voltage waveform is divided into three parts by two threshold voltages, and (ii) two parts positioned at either ends of the voltage waveform where a fall of the voltage waveform is divided into three parts by the two threshold voltages.

20. A counter electrode driving method for causing a counter electrode drive circuit to drive a counter electrode,
the counter electrode drive circuit AC driving a counter electrode used in a liquid crystal display device, the counter electrode drive circuit including: an amplifier for generating a voltage to be applied to the counter electrode, the amplifier including (i) a first transistor made up of a p-channel type field effect transistor that outputs to the counter electrode a high-level voltage of the AC driving and (ii) a second transistor made up of a n-channel type field effect transistor that outputs to the counter electrode a low-level voltage of the AC driving,
the counter electrode driving method comprising:
detecting an output from the amplifier;
while the output of the amplifier is outputted from the first transistor, reducing a voltage of a driving signal inputted into a gate of the first transistor to be lower during a time when the output of the amplifier is higher than a first threshold voltage, as compared to during a time when the output of the amplifier is lower than the first threshold voltage; and
while the output of the amplifier is outputted from the second transistor, reducing a voltage of a driving signal inputted into a gate of the second transistor to be lower during a time when the output of the amplifier is lower than a second threshold voltage that is lower than the first threshold voltage, as compared to during a time when the output of the amplifier is higher than the first threshold voltage.

21. A counter electrode driving method for causing a counter electrode drive circuit to drive a counter electrode,
the counter electrode drive circuit AC driving a counter electrode used in a liquid crystal display device, the counter electrode drive circuit including: an amplifier for generating a voltage to be applied to the counter electrode, the amplifier including (i) a first transistor made up of a p-channel type field effect transistor that outputs to the counter electrode a high-level voltage of the AC driving, and (ii) a second transistor made up of a n-channel type field effect transistor that outputs to the counter electrode a low-level voltage of the AC driving,
the counter electrode driving method comprising:
detecting an output from the amplifier;
while the output of the amplifier is outputted from the first transistor, reducing a voltage of a driving signal inputted into a gate of the first transistor to be lower during a time when the output from the amplifier is higher than a first threshold voltage and is lower than the high-level voltage, as compared to during a time when the output from the amplifier is lower than the first threshold voltage and is in a high-level state; and
while the output of the amplifier is outputted from the second transistor, reducing a voltage of a driving signal inputted into a gate of the second transistor to be lower during a time when the output from the amplifier is lower than a second threshold voltage that is lower than the first threshold voltage and the output from the amplifier is higher than the low-level voltage, as compared to during a time when the output from the amplifier is higher than the first threshold voltage and is in a low-level state.
